(19) United States
(12) Patent Application Publication
(10) Pub. No.: US 2018/0001588 A1
(43) Pub. Date: Jan. 4, 2018

(54) AUTOMATED MULTI-PURPOSE QUILLING DEVICE

(71) Applicant: Disha KATHARANI, Mumbai (IN)

(72) Inventor: Disha KATHARANI, Mumbai (IN)

(21) Appl. No.: 15/514,800

(22) PCT Filed: Mar. 26, 2016
(86) PCT No.: PCT/IB2016/051735

§ 371 Date: Mar. 27, 2017

(30) Foreign Application Priority Data
Mar. 25, 2015 (IN) 993/MUM/2015

(51) Int. Cl. B31C 11/02; B44B 11/04; B25F 3/00; B41K 1/00; B65H 54/58; B44C 5/00

(52) U.S. Cl. CPC B31C 11/02; B65H 54/585; B44C 5/00; B25F 3/00; B41K 1/003; B44B 11/04

(57) ABSTRACT

An automated multi-purpose quilling device includes a housing and a driver element. The housing accommodates an electrical unit. The housing defines a through-hole and is configured to receive at least one tool attachment to perform one or more functions of quilling. The driver element is attached to the electrical unit of the housing. A first end of the driver element is placed onto the electrical unit within the housing and a second end of the driver element protrudes externally from the through-hole. The second end of the driver element is configured to receive the at least one tool attachment. The driver element is further configured to rotate when actuated by the electrical unit and in turn operate the at least one tool attachment.

### CROSS-REFERENCE TO RELATED APPLICATIONS

This application claims priority to Indian Provisional Patent Application No. 993/MUM/2015, filed on Mar. 20, 2015, which is incorporated herein by reference in its entirety.

### FIELD OF THE INVENTION

The present invention generally relates to quilling devices and more particularly to an automated multi-purpose quilling device for quilling.

### BACKGROUND TO THE INVENTION

Quilling is an art form that is also referred to as paper-rolling, paper-scrolling, filigree, and paper mosaic. The quilling typically involves rolling, shaping and gluing strips of paper to create one or more decorative designs. The quilling is a term that was derived from early quillers who used feathers or quills to roll the strips of paper. The quilling is extremely diverse and can be used in scrapbooking, card making, as decorative borders for poetry, antique photographs, paperweights, baby and wedding announcements, gift tags, and the like. Dimensional figurines and jewelry can also be created using the quilling. Throughout history, crafters have used a variety of different tools to assist in winding the strips of paper. More modern implements include needles, hairpins and most recently, narrow dowels that have a slot to hold a strip of paper in place as the strip of paper is wound.

A number of different quilling tools are in existence. For example, a paper quilling tool provides a flat surface for paper strips to be wound. The flat surface includes a small hole in center for a slotted quilling tool to be inserted in bottom. A slotted tip of the slotted quilling tool then protrudes outwards. A paper strip is inserted into the slotted tip and the slotted quilling tool is rotated to wind the paper strip around the slotted tip. The flat surface allows the paper strip to be rolled while keeping edges of the paper strip even, providing a coiled paper shape needed for the quilling. However, the paper quilling tool requires a great amount of manual effort to create neat and tight coils.

In another example, a quilling tool includes a turning device with a cavity, a fixed spindle displaced from the turning device, a rewinding spindle with a slot and a connector base. The connector base is shaped to fit into a shaped cavity so that part of the rewinding spindle sits above the cavity and the rewinding spindle rotates when the turning device rotates. However, only one type of quilling pattern can be achieved from such quilling tool and different tools must be employed to get different patterns which is tedious and time consuming.

### SUMMARY OF THE INVENTION

This summary is provided to introduce a selection of concepts in a simplified format that are further described in the detailed description of the invention. This summary is not intended to identify key or essential inventive concepts of the subject matter, nor is it intended for determining the scope of the invention.

An automated multi-purpose quilling device includes a housing and a driver element. The housing accommodates an electrical unit. The housing defines a through-hole and is configured to receive at least one tool attachment to perform one or more functions of quilling. The driver element is attached to the electrical unit of the housing. A first end of the driver element is placed onto the electrical unit within the housing and a second end of the driver element protrudes externally from the through-hole. The second end of the driver element is configured to receive the at least one tool attachment. The driver element is further configured to rotate when actuated by the electrical unit and in turn operate the at least one tool attachment.

An automated multi-purpose quilling device includes a housing, an electrical unit, and a driver element. The housing accommodates an electrical unit. The housing defines a through-hole and is configured to receive at least one tool attachment to perform one or more functions of quilling. The electrical unit includes a motor and a power source. The motor includes a shaft. The power source is coupled to the motor and is configured to electrically power the motor using a switch. The driver element is attached to the electrical unit. A first end of the driver element is placed onto the shaft of the motor and a second end of the driver element protrudes externally from the through-hole. The second end of the driver element is configured to receive the at least one tool attachment. The driver element is further configured to rotate when actuated by the electrical unit and in turn operate the at least one tool attachment.

To further clarify advantages and features of the present invention, a more particular description of the invention will be rendered by reference to specific embodiments thereof, which is illustrated in the appended figures. It is appreciated that these figures depict only typical embodiments of the invention and are therefore not to be considered limiting of its scope. The invention will be described and explained with additional specificity and detail with the accompanying figures.

### BRIEF DESCRIPTION OF THE DRAWINGS

The invention will be described and explained with additional specificity and detail with the accompanying figures in which:

FIG. 1A illustrates a front view of an automated multi-purpose quilling device, in accordance with an embodiment;

FIG. 1B illustrates a side perspective view of an automated multi-purpose quilling device, in accordance with an embodiment;

FIG. 1C illustrates a side perspective view of a cap of an automated multi-purpose quilling device, in accordance with an embodiment;

FIG. 2A illustrates a front view of a first half of an automated multi-purpose quilling device, in accordance with an embodiment;

FIG. 2B illustrates a front view of a H-shaped element of an automated multi-purpose quilling device, in accordance with an embodiment;

FIG. 2C illustrates a front view of a battery cover of the automated multi-purpose quilling device, in accordance with an embodiment;

FIG. 2D illustrates a top view of a housing of an automated multi-purpose quilling device, in accordance with an embodiment;

FIG. 2E illustrates a front view of a second half of an automated multi-purpose quilling device, in accordance with an embodiment;

FIG. 3A illustrates an exploded view of a slotted tool attachment on an automated multi-purpose quilling device, in accordance with an embodiment;

FIG. 3B illustrates a front view of a slotted pin of a slotted tool attachment, in accordance with an embodiment;

FIG. 3C illustrates a front view of a slotted element of a slotted tool attachment, in accordance with an embodiment;

FIG. 3D illustrates a front view of a slotted pin and a slotted element of a slotted tool attachment attached to a H-shaped element of an automated multi-purpose quilling device, in accordance with an embodiment;

FIG. 3E illustrates a front view of an automated multi-purpose quilling device with a slotted tool attachment, in accordance with an embodiment;

FIG. 4A illustrates a side perspective view of a crimping tool attachment for an automated multi-purpose quilling device, in accordance with an embodiment;

FIG. 4B illustrates an exploded side view of a crimping tool attachment on an automated multi-purpose quilling device, in accordance with an embodiment;

FIG. 4C illustrates a side view of an automated multi-purpose quilling device with a crimping tool attachment, in accordance with an embodiment;

FIG. 4D illustrates a sectional front view of a crimping tool attachment, in accordance with an embodiment;

FIG. 4E illustrates a sectional top view of a crimping tool attachment, in accordance with an embodiment;

FIG. 4F illustrates a sectional side view of a crimping tool attachment, in accordance with an embodiment;

FIG. 5A illustrates an exploded front view of a beading tool attachment for an automated multi-purpose quilling device, in accordance with an embodiment;

FIG. 5B illustrates an exploded side view of a beading tool attachment on an automated multi-purpose quilling device, in accordance with an embodiment;

FIG. 5C illustrates a side view of an automated multi-purpose quilling device with a beading tool attachment, in accordance with an embodiment;

FIG. 5D illustrates a front view of a first dome of a beading tool attachment, in accordance with an embodiment;

FIG. 5E illustrates a front view of a second dome of a beading tool attachment, in accordance with an embodiment;

FIG. 5F illustrates a side view of a plunger of a beading tool attachment, in accordance with an embodiment;

FIG. 5G illustrates a front view of a pin of a beading tool attachment, in accordance with an embodiment;

FIG. 6A illustrates an exploded front view of a ring coil tool attachment on an automated multi-purpose quilling device, in accordance with an embodiment;

FIG. 6B illustrates a front view of an automated multi-purpose quilling device with a ring coil tool attachment, in accordance with an embodiment;

FIG. 6C illustrates a top view of a removable stencil disk of a ring coil tool attachment, in accordance with an embodiment; and

FIG. 6D illustrates a top view of a removable stencil disk of a ring coil tool attachment, in accordance with another embodiment.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having benefit of the description herein.

### DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

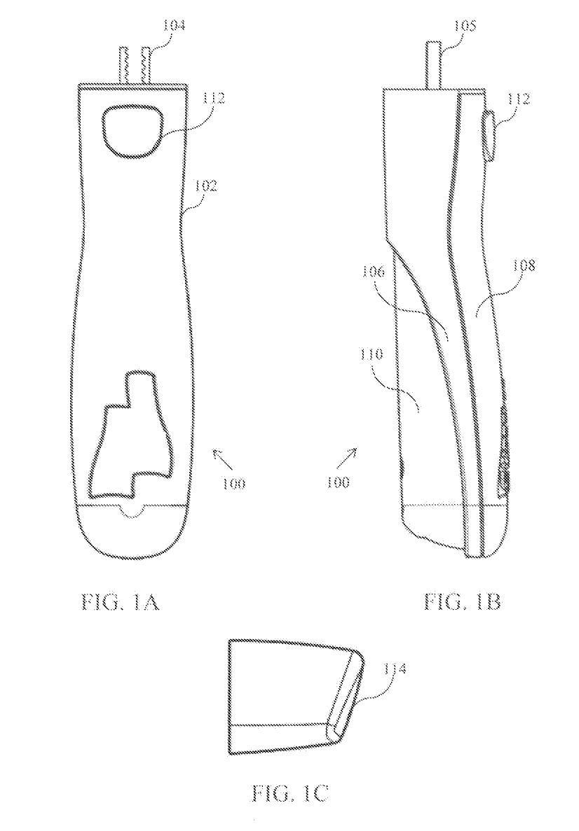

FIG. 1A and FIG. 1B illustrate a front view and a side perspective view of an automated multi-purpose quilling device 100, respectively. The automated multi-purpose quilling device 100 includes a housing 102, and a driver element, for example a H-shaped element 104. In this embodiment, the driver element is the H-shaped element 104, and the present disclosure is explained with respect to the H-shaped element 104. However, it should be understood that the driver element can include elements of different shapes and sizes and is not limited to the H-shaped element 104. In an example, the housing 102 is a plastic housing. The housing 102 is illustrated to include a first half 106 and a second half 108. The first half 106 and the second half 108 can be joined together to define an interior space thereon with a closed bottom portion. In an example, the housing 102 can be covered with a cap. The first half 106 also includes a battery cover 110. The H-shaped element 104 is held by the housing 102 and protrudes external from the housing 102. In an example, the H-shaped element 104 is a metallic element. In some embodiments, the H-shaped element 104 is a plastic element.

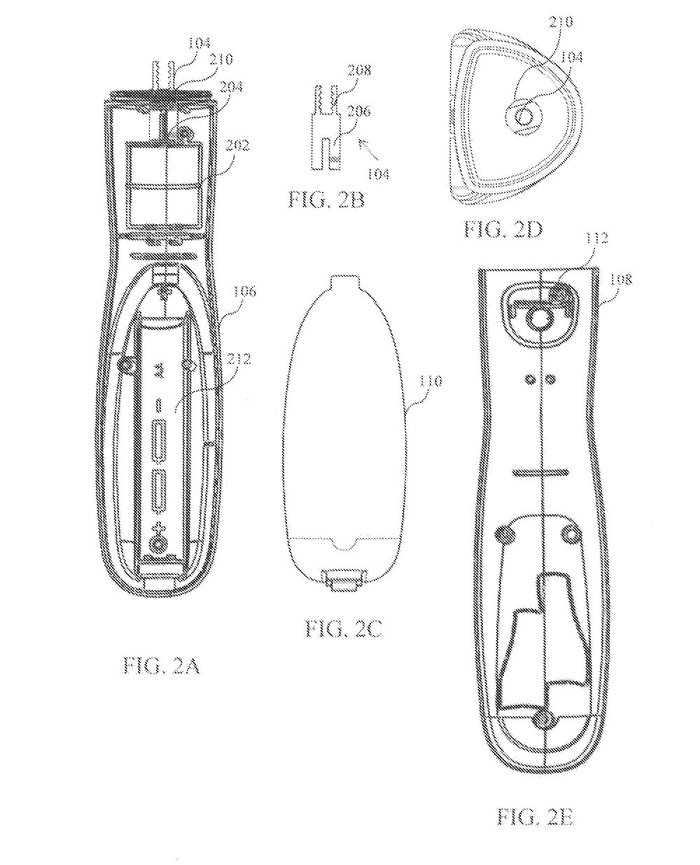

The second half 108 of the housing 102 includes a switch 112. The housing 102 is configured to receive at least one tool attachment. Examples of the at least one attachments include, but are not limited to, a slotted tool attachment, a crimping tool attachment, a beading tool attachment, a ring coil tool attachment, a fringing and cutting tool attachment, a ball and socket tool attachment, a stamp print tool attachment, an embossing tool attachment, and the like. In an example, the housing 102 can be covered with a cap 114, as illustrated in FIG. 1C. The housing 102 is further explained in detail with reference to FIGS. 2A to 2E.

FIG. 2A illustrates a front view of a first half 106 of the automated multi-purpose quilling tool 100. The first half 106 includes an electrical unit and the H-shaped element 104. The electrical unit includes a motor 202 and a power source (not shown in FIG. 2A). The motor 202 is powered by a power source and is controlled by the switch 112. The motor 202 includes a shaft 204 at top end of the motor 202. The electrical unit employed in the automated multi-purpose quilling tool 100 eliminates need of manual effort and thus provides an easy and efficient way for quilling a strip of paper. The shaft 204 receives the H-shaped element 104. The H-shaped element 104 is illustrated in FIG. 2B and includes a first end 206 and a second end 208. The first end 206 of the H-shaped element 104 includes a first groove and is placed onto the shaft 204 of the motor 202. The shaft 204 is held within the first groove of the first end 206. The second end 208 of the H-shaped element 104 protrudes externally from a through-hole 210 in the housing 102.

In this embodiment, the H-shaped element 104 and the motor 202 are separate elements and are attached to each other during assembling of the automated multi-purpose quilling tool 100. In other embodiments, the H-shaped element 104 and the motor 202 are manufactured as a single unit enabling cost reductions and easy assembling of the automated multi-purpose quilling tool 100.

The second end 208 of the H-shaped element 104 is configured to receive the at least one tool attachment. The H-shaped element 104 further rotates when actuated by the electrical unit. The power source is placed in a slot 212 and enclosed with a battery cover 110 (illustrated in FIG. 2C). In some embodiments, the power source can include one or more batteries. In other embodiments, the power source can include one of a solar component, a charging dock, a direct plug-in system, and the like. The first half 106 can hence be configured to either include the slot 212 or not include the slot 212, in accordance with the power source being used.

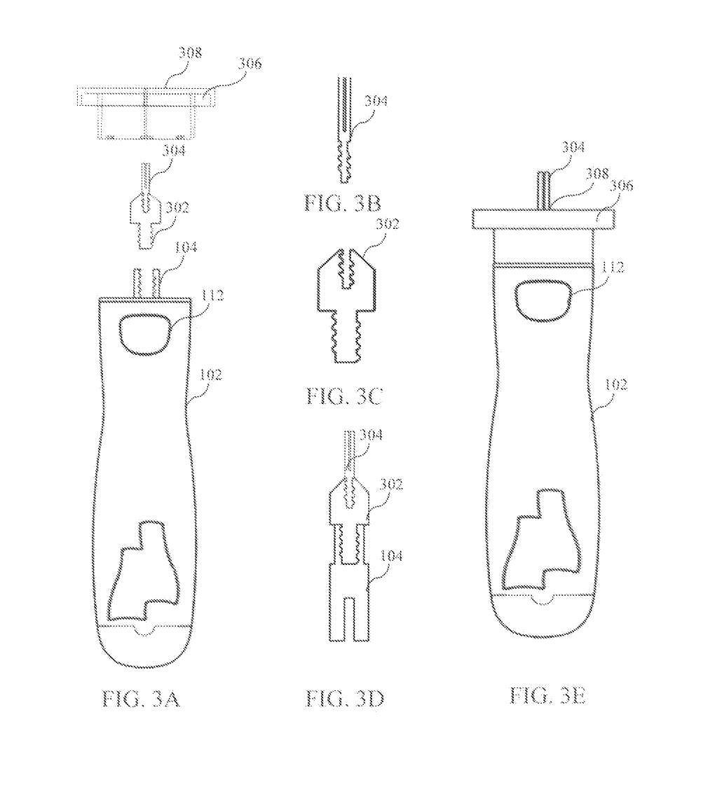

A user can press the switch 112 to power the motor 202. The motor 202 rotates thereby also rotating the H-shaped element 104 and a tool attachment fixed to the H-shaped element 104. A top view of the housing 102 depicts the H-shaped element 104 being lodged within the through-hole 210, as illustrated in FIG. 2D. The second half 108, as illustrated in FIG. 2E and including the switch 112, is placed over the first half 106 to form the housing 102. The housing 102 with a slotted tool attachment is explained further with reference to FIGS. 3A to 3B.

FIG. 3A illustrates an exploded view of the automated multi-purpose quilling device 100 with a slotted tool attachment. The slotted tool attachment includes a slotted element 302, a slotted pin 304, and a first disk 306. The slotted element 302 is as illustrated in FIG. 3C. A top end of the slotted element 302 includes a groove into which the slotted pin 304 is received. A bottom end of the slotted element 302 is a screw that is positioned in the second end 208 of the H-shaped element 104. The slotted pin 304 is positioned in the top end of the slotted element 302 and includes a slot for receiving at least one quilling strip. The slotted pin 304 is as illustrated in FIG. 3B.

Attachment of the slotted pin 304, the slotted element 302, and the H-shaped element 104 is illustrated in FIG. 3D. The first disk 306 is positioned around the slotted pin 304 and the slotted element 302 to rest over the housing 102. The first disk 306 includes a first through-hole 308 through which the top end of the slotted pin 304 protrudes out. The automated multi-purpose quilling tool 100 attached with the slotted tool attachment is illustrated in FIG. 3E.

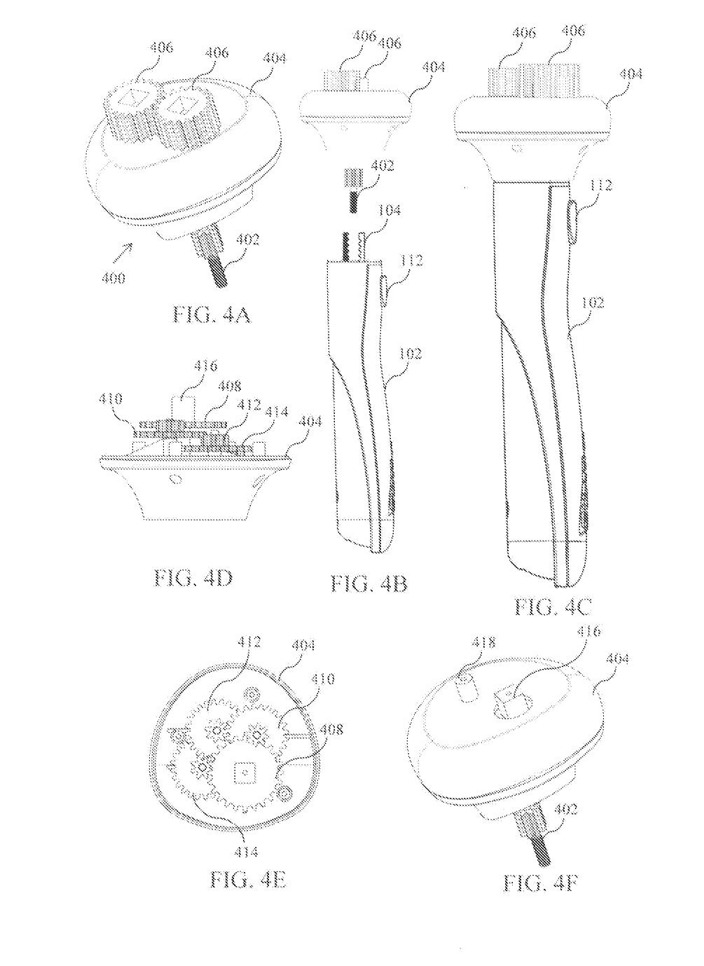

FIG. 4A illustrates a side perspective view of a crimping tool attachment 400 for the automated multi-purpose tool attachment 100, and FIG. 4B illustrates an exploded view of the crimping tool attachment 400 on the automated multi-purpose tool attachment 100. The crimping tool attachment 400 includes a pinion 402, a second disk 404, and at least one crimping gear 406. The pinion 402 is positioned in the second end 208 of the H-shaped element 104. The second disk 404 is positioned around the pinion 402 to rest over the housing 102. The second disk 404 internally includes at least one double gear, as illustrated in FIGS. 4D and 4E. A bottom portion of the second disk 404 holds double gears, for example a first gear 408, a second gear 410, a third gear 412, and a fourth gear 414. The double gears can be positioned such that the double gears engage each other to transmit motion.

The first gear 408 can include an elongated element 416 that protrudes outside the second disk 404, as illustrated in FIG. 4F. A top portion of the second disk 404 covers the bottom portion such that the elongated element 416 protrudes out. The top portion includes a stationary element 418 located near to the elongated element 416. The crimping gear 406 is positioned over the second disk 404. For instance, one crimping gear is positioned over the elongated element 416 and rotates in accordance with the elongated element 416 when the automated multi-purpose quilling device 100 is actuated. Another crimping gear is positioned over the stationary element 418, as illustrated in FIG. 4A, and is rotated by the crimping gear positioned on the elongated element 416.

In an example, the user places the at least one quilling strip between two crimping gears for crimping. The pinion 402 interlocks with the double gears (reduction gears) inside the crimping tool attachment 400 and output speed of the automated multi-purpose quilling tool 100 is reduced and output torque is increased. Increase of the output torque facilitates crimping of the quilling strip without need to change to a high power motor. A crimped effect gives the quilling strip a pattern and the quilling strip can then be used to make coils or pasted as borders. The automated multi-purpose quilling tool 100 attached with the crimping tool attachment 400 is illustrated in FIG. 4C.

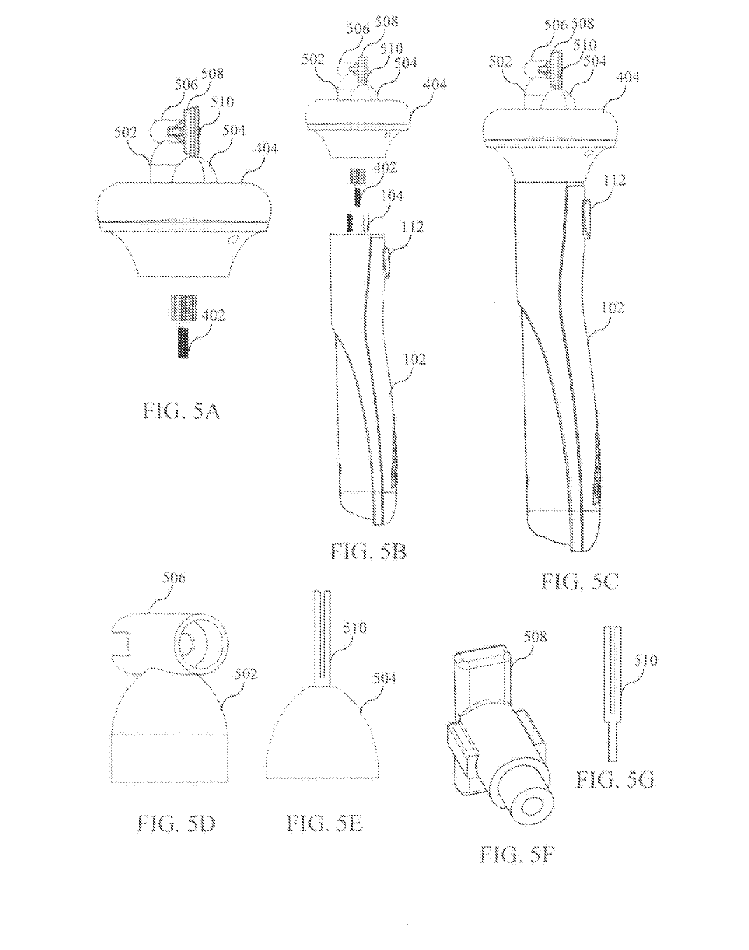

FIG. 5A illustrates an exploded front view of a beading tool attachment 500 for the automated multi-purpose tool attachment 100, and FIG. 5B illustrates an exploded side view of the beading tool attachment 500 on the automated multi-purpose tool attachment 100. The beading tool attachment 500 includes the pinion 402, the second disk 404, and a plurality of domes. The pinion 402 is positioned in the second end 208 of the H-shaped element 104. The second disk 404 is positioned around the pinion 402 to rest over the housing 102. The second disk 404 internally includes at least one double gear, as illustrated and explained with reference to FIGS. 4D, 4E and 4F.

The domes include a first dome 502, as illustrated in FIG. 5D, and a second dome 504, as illustrated in FIG. 5E. The first dome 502 is positioned higher than the second dome 504. A top end of the first dome 502 includes a cylindrical attachment 506. The cylindrical attachment 506 is further configured to receive a beading plunger 508, as illustrated in FIG. 5F. A top end of the second dome 504 includes a pin 510. The pin 510 is slotted and further configured to receive the quilling strip. The pin 510 is of an increased height and width as compared to the slotted pin 304, as illustrated in FIG. 5G. The domes can be positioned over the second disk 404. For instance, the second dome 504 is positioned over the elongated element 416 and rotates in accordance with the elongated element 416 when the automated multi-purpose quilling device 100 is actuated. The first dome 502 is positioned over the stationary element 418 and is configured to host the beading plunger 508. The beading plunger 508 holds the quilling strip steady as the quilling strip is being wound around the pin 510. A spring can also be included within the beading plunger 508 that is pushed back as the quilling strip winds and the beading plunger 508 further continues to provide support.

The pinion 402 interlocks with the double gears (reduction gears) inside the beading tool attachment 500 and the output speed of the automated multi-purpose quilling tool 100 is reduced and the output torque is increased. The quilling strip used for making beads is often wider than the quilling strip used for the quilling. Increased output torque helps even a wider strip to get coiled with the motor 202. The reduced speed along with the beading plunger 508 (that holds the quilling strip in place) helps in shaping the beads with ease. The beads can have several different shapes and sizes based on shape of the quilling strip used. The automated multi-purpose quilling tool 100 attached with the beading tool attachment 500 is illustrated in FIG. 5C.

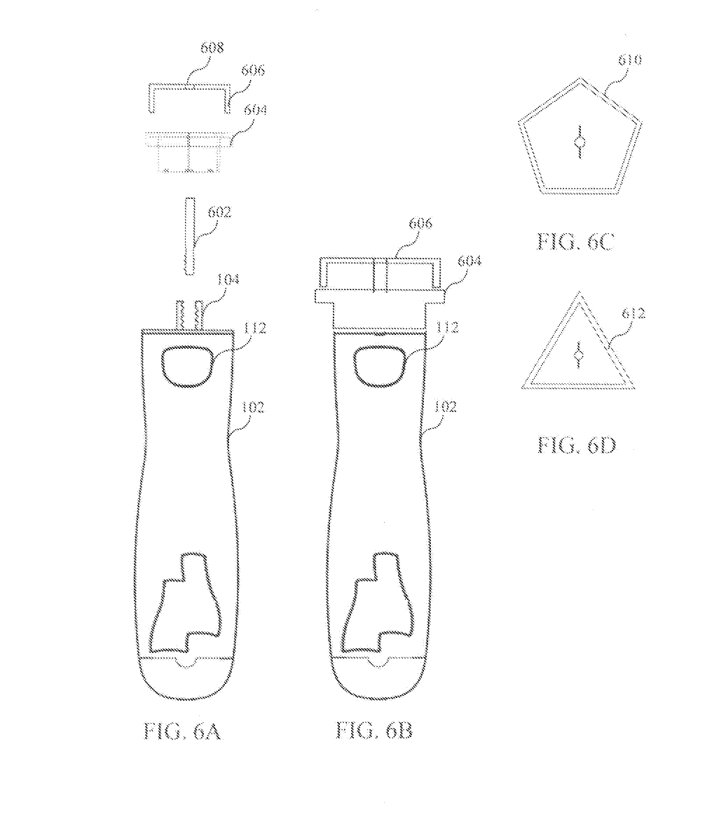

FIG. 6A illustrates an exploded front view of a ring coil tool attachment on the automated multi-purpose tool attachment 100. The ring coil tool attachment includes the ring coil pin 602, a stencil disk 604, and a stencil 606. The stencil disk 604 is stationary and the stencil 606 is rotational. The ring coil pin 602 is positioned in the second end 208 of the H-shaped element 104. The stencil disk 604 is positioned around the ring coil pin 602 through a second through-hole 608 to rest over the housing 102. The stencil 606 is placed over the stencil disk 604. The ring coil pin 602 extends through the second through-hole 608, a tight-fit hole, to securely attach itself to the stencil 606. Such a secure attachment ensures that the stencil 606 rotates when the automated multi-purpose quilling tool 100 is actuated. The quilling strip is wound around the stencil 606 when the stencil 606 rotates.

The stencil 606 rotates along with the ring coil pin 602 to generate a ring shaped coil around the stencil 606 and in shape of the stencil 606. The ring shaped coil has a hollow center in the shape and size of the stencil 606. Thickness of the ring shaped coil can be chosen to vary based on desired design. The ring shaped coils can be used in 2D and 3D quilling and crafts. Some examples of the stencil 606 include the stencil 610, as illustrated in FIG. 6C, and the stencil 612, as illustrated in FIG. 6D. It should be understood that the stencil 606 can be represented in other shapes and sizes and should not be limited to stencils illustrated in FIGS. 6C and 6D. The automated multi-purpose quilling tool 100 attached with the ring coil tool attachment is illustrated in FIG. 6B.

Other tool attachments can also be used with the automated multi-purpose quilling tool 100 and are explained further. A fringing and cutting tool attachment enables one or more cuts in the at least one quilling strip to generate a pattern. The fringing and cutting tool includes a roller element and a blade element. The roller element is configured to receive the at least one quilling strip and push forward the at least one quilling strip on being powered by the electrical unit. The blade element is coupled to the roller element and configured to perform fringing and cutting along length of the at least one quilling strip being received from the roller element.

A ball and socket tool attachment is used to generate a three dimensional coil and includes a pin, a removable disk, and a ball and socket joint. The pin is positioned in the second end 208 of the H-shaped element 104. The removable disk is positioned around the pin to rest over the housing 102. The removable disk includes a third through-hole and a top end of the pin protrudes from the third through-hole. The ball and socket joint is positioned in the top end of the pin and configured to rotate in response to the electrical unit being powered. The ball and socket joint further is configured to receive at least one quilling strip and to generate the three dimensional coil in different shapes, for example cones and domes. The ball and socket joint can have different combinations and will have a slit in which the quilling strip can be inserted. After the quilling strip has been coiled, the ball and socket joint can be removed from the metal pin along with the coil. The ball and socket joints can then serve as connectors and the shapes can form basis of a 3D construction system.

A stamp print tool attachment is used for imprinting one or more patterns in the at least one quilling strip. The stamp print tool attachment includes a stamp roller element and a stamp print element. The stamp roller element is configured to receive the at least one quilling strip and push forward the at least one quilling strip on being powered by the electrical unit. The stamp print element is coupled to the stamp roller element and configured to imprint the one or more patterns along length of the at least one quilling strip being received from the stamp roller element. In some embodiments, the stamp print element can be interchangeable to allow imprinting different patterns. Ink of the stamp print element can be interchangeable to allow imprinting the pattern in different colours. Patterned strips can then be used to make coils or be pasted as borders.

An embossing tool attachment is used for embossing one or more patterns in the at least one quilling strip. The embossing tool attachment includes an embossing roller element and an embossing element. The embossing roller element is configured to receive the at least one quilling strip and push forward the at least one quilling strip on being powered by the electrical unit. The embossing element is coupled to the embossing roller element and configured to emboss the one or more patterns along length of the at least one quilling strip being received from the embossing roller element. In some embodiments, the embossing element can be interchangeable to allow embossing different patterns. Patterned strips can then be used to make coils or be pasted as borders.

The automated multi-purpose quilling tool 100 of the present invention can be employed to perform multiple quilling functions including, but not limited to, create coils, to create ring coils with hollow center and to create crimped strips. The automated multi-purpose quilling tool 100 does not require any manual effort and performs the quilling functions automatically in less time when actuated using the switch 112. The automated multi-purpose quilling tool 100 has multiple replaceable tool attachments which enable the present invention to be employed to perform multiple quilling functions with convenience and ease. The automated multi-purpose quilling tool 100 is efficient as time required to make a coil reduces by more than 80% as compared to time taken by a manual quilling tool. The automated multi-purpose quilling tool 100 is further cost efficient as use of reduction gear mechanism allows a low cost motor to be used to perform multiple actions (including functions requiring higher torque). The multi-purpose nature of the automated multi-purpose quilling tool 100 also negates need for multiple devices. The coils and patterns are neater and more consistent when made with the automated multi-purpose quilling tool 100.

While specific language has been used to describe the disclosure, any limitations arising on account of the same are not intended. As would be apparent to a person in the art, various working modifications may be made to the method in order to implement the inventive concept as taught herein.

The figures and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

We claim:

1. An automated multi-purpose quilling device comprising:
a housing for accommodating an electrical unit, the housing defining a through-hole and configured to receive at least one tool attachment to perform one or more functions of quilling; and
a driver element attached to the electrical unit of the housing, a first end of the driver element being placed onto the electrical unit within the housing and a second end of the driver element protruding externally from the through-hole, the second end of the driver element configured to receive the at least one tool attachment, the driver element further configured to rotate when actuated by the electrical unit and in turn operate the at least one tool attachment.

2. The automated multi-purpose quilling device as claimed in claim 1, wherein the at least one tool attachment comprises a slotted tool attachment for curling at least one quilling strip into a coil, the slotted tool attachment comprising:
a slotted element positioned in the second end of the driver element;
a slotted pin positioned in the slotted element, the slotted pin comprising a slot for receiving the at least one quilling strip; and
a first disk positioned around the slotted pin and the slotted element to rest over the housing, wherein the first disk comprises a first through-hole, a top end of the slotted pin protruding from the first through-hole.

3. The automated multi-purpose quilling device as claimed in claim 1, wherein the at least one tool attachment comprises a crimping tool attachment for crimping at least one quilling strip, and wherein the crimping tool attachment comprises
a pinion positioned in the second end of the driver element;
a second disk positioned around the pinion to rest over the housing, wherein the second disk internally comprises at least one double gear; and
at least one crimping gear positioned over the second disk, the at least one crimping gear configured to receive the at least one quilling strip for the crimping.

4. The automated multi-purpose quilling device as claimed in claim 1, wherein the at least one tool attachment comprises a beading tool attachment for beading at least one quilling strip, and wherein the beading tool attachment comprises:
a pinion positioned in the second end of the driver element;
a second disk positioned around the pinion to rest over the housing, wherein the second disk internally comprises at least one double gear; and
a plurality of domes positioned over the second disk, a first dome of the plurality of domes positioned higher than a second dome of the plurality of domes, a top end of the first dome comprising a cylindrical attachment, the cylindrical attachment further configured to receive a beading plunger.

5. The automated multi-purpose quilling device as claimed in claim 1, wherein the electrical unit comprises:
a motor configured to rotate the driver element, wherein the motor comprises a shaft, the shaft configured to receive the first end of the driver element; and
a power source coupled to the motor and configured to electrically power the motor using a switch.

6. The automated multi-purpose quilling device as claimed in claim 1, wherein the at least one tool attachment comprises a ring coil tool attachment for curling at least one quilling strip into a ring shaped coil, the ring coil tool attachment comprising:
a ring coil pin positioned in the second end of the driver element;
a stencil disk positioned around the ring coil pin to rest over the housing, wherein the stencil disk comprises a second through-hole, the ring coil pin extending from the second through-hole;
a stencil positioned over the stencil disk and around the ring coil pin, the stencil configured to receive the at least one quilling strip and rotate along with the ring coil pin to generate the ring shaped coil.

7. The automated multi-purpose quilling device as claimed in claim 1, wherein the at least one tool attachment comprises a fringing and cutting tool attachment for enabling one or more cuts in at least one quilling strip to generate a pattern, the fringing and cutting tool attachment comprising:
a roller element configured to receive the at least one quilling strip and push forward the at least one quilling strip on being powered by the electrical unit; and
a blade element coupled to the roller element and configured to perform fringing and cutting along length of the at least one quilling strip being received from the roller element.

8. The automated multi-purpose quilling device as claimed in claim 1, wherein the at least one tool attachment comprises a ball and socket tool attachment for generating a three dimensional coil, the ball and socket tool attachment comprising:
a pin positioned in the second end of the driver element;
a removable disk positioned around the pin to rest over the housing, wherein the removable disk comprises a third through-hole, a top end of the pin protruding from the third through-hole; and
a ball and socket joint positioned in the top end of the pin and configured to rotate in response to the electrical unit being powered, the ball and socket joint further configured to receive at least one quilling strip and to generate the three dimensional coil.

9. The automated multi-purpose quilling device as claimed in claim 1, wherein the at least one tool attachment comprises a stamp print tool attachment for imprinting one or more patterns in at least one quilling strip, the stamp print tool attachment comprising:
a stamp roller element configured to receive the at least one quilling strip and push forward the at least one quilling strip on being powered by the electrical unit; and
a stamp print element coupled to the stamp roller element and configured to imprint the one or more patterns along length of the at least one quilling strip being received from the stamp roller element.

10. The automated multi-purpose quilling device as claimed in claim 1, wherein the at least one tool attachment comprises an embossing tool attachment for embossing one or more patterns in at least one quilling strip, the embossing tool attachment comprising:
an embossing roller element configured to receive the at least one quilling strip and push forward the at least one quilling strip on being powered by the electrical unit; and
an embossing element coupled to the embossing roller element and configured to emboss the one or more patterns along length of the at least one quilling strip being received from the embossing roller element.

11. An automated multi-purpose quilling device comprising:
a housing for accommodating an electrical unit, the housing defining a through-hole and configured to receive at least one tool attachment to perform one or more functions of quilling;
the electrical unit comprising a motor and a power source, the motor comprising a shaft, the power source coupled to the motor and configured to electrically power the motor using a switch; and
a driver element attached to the electrical unit, a first end of the driver element being placed onto the shaft of the motor and a second end of the driver element protruding externally from the through-hole, the second end of the driver element configured to receive the at least one tool attachment, the driver element further configured to rotate when actuated by the electrical unit and in turn operate the at least one tool attachment.

12. The automated multi-purpose quilling device as claimed in claim 11, wherein the at least one tool attachment comprises a slotted tool attachment for curling at least one quilling strip into a coil, the slotted tool attachment comprising:
a slotted element positioned in the second end of the driver element;
a slotted pin positioned in the slotted tool, the slotted pin comprising a slot for receiving the at least one quilling strip; and
a first disk positioned around the slotted pin and the slotted element to rest over the housing, wherein the first disk comprises a first through-hole, a top end of the slotted pin protruding from the first through-hole.

13. The automated multi-purpose quilling device as claimed in claim 11, wherein the at least one tool attachment comprises a crimping tool attachment for crimping at least one quilling strip, and wherein the crimping tool attachment comprises
a pinion positioned in the second end of the driver element;
a second disk positioned around the pinion to rest over the housing, wherein the second disk internally comprises at least one double gear; and
at least one crimping gear positioned over the second disk, the at least one crimping gear configured to receive the at least one quilling strip for the crimping.

14. The automated multi-purpose quilling device as claimed in claim 11, wherein the at least one tool attachment comprises a beading tool attachment for beading at least one quilling strip, and wherein the beading tool attachment comprises:
a pinion positioned in the second end of the driver element;
a second disk positioned around the pinion to rest over the housing, wherein the second disk internally comprises at least one double gear; and
a plurality of domes positioned over the second disk, a first dome of the plurality of domes positioned higher than a second dome of the plurality of domes, a top end of the first dome comprising a cylindrical attachment, the cylindrical attachment further configured to receive a beading plunger.

15. The automated multi-purpose quilling device as claimed in claim 11, wherein the at least one tool attachment comprises a ring coil tool attachment for curling at least one quilling strip into a ring shaped coil, the ring coil tool attachment comprising:
a ring coil pin positioned in the second end of the driver element;
a stencil disk positioned around the ring coil pin to rest over the housing, wherein the stencil disk comprises a second through-hole, the ring coil pin extending from the second through-hole; and
a stencil positioned over the stencil disk and around the ring coil pin, the stencil configured to receive the at least one quilling strip and rotate along with the ring coil pin to generate the ring shaped coil.

16. The automated multi-purpose quilling device as claimed in claim 11, wherein the at least one tool attachment comprises a fringing and cutting tool attachment for enabling one or more cuts in at least one quilling strip to generate a pattern, the fringing and cutting tool attachment comprising:
a roller element configured to receive the at least one quilling strip and push forward the at least one quilling strip on being powered by the electrical unit; and
a blade element coupled to the roller element and configured to perform fringing and cutting along length of the at least one quilling strip being received from the roller element.

17. The automated multi-purpose quilling device as claimed in claim 11, wherein the at least one tool attachment comprises a ball and socket tool attachment for generating a three dimensional coil, the ball and socket tool attachment comprising:
a pin positioned in the second end of the driver element;
a removable disk positioned around the pin to rest over the housing, wherein the removable disk comprises a third through-hole, a top end of the pin protruding from the third through-hole; and
a ball and socket joint positioned in the top end of the pin and configured to rotate in response to the electrical unit being powered, the ball and socket joint further configured to receive at least one quilling strip and to generate the three dimensional coil.

18. The automated multi-purpose quilling device as claimed in claim 11, wherein the at least one tool attachment comprises a stamp print tool attachment for imprinting one or more patterns in at least one quilling strip, the stamp print tool attachment comprising:
a stamp roller element configured to receive the at least one quilling strip and push forward the at least one quilling strip on being powered by the electrical unit; and
a stamp print element coupled to the stamp roller element and configured to imprint the one or more patterns along length of the at least one quilling strip being received from the stamp roller element.

19. The automated multi-purpose quilling device as claimed in claim 11, wherein the at least one tool attachment comprises an embossing tool attachment for embossing one or more patterns in at least one quilling strip, the embossing tool attachment comprising:
an embossing roller element configured to receive the at least one quilling strip and push forward the at least one quilling strip on being powered by the electrical unit; and
an embossing element coupled to the embossing roller element and configured to emboss the one or more patterns along length of the at least one quilling strip being received from the embossing roller element.

20. The automated multi-purpose quilling device as claimed in claim 11, wherein driver element and the motor of the electrical unit is a single unit.
